(19) United States
(12) Patent Application Publication
(10) Pub. No.: US 2014/0379436 A1
(43) Pub. Date: Dec. 25, 2014

(54) HOLIDAY PERFORMANCE REPORTS

(71) Applicant: Google Inc., Mountain View, CA (US)

(72) Inventors: Daniel Robert White, London (GB); Daniel Matthew Goodridge, London (GB); Madeleine Cule, London (GB); Gjokica Zafirovski, London (GB); Louis Aidan Collard, London (GB)

(21) Appl. No.: 13/924,096

(22) Filed: Jun. 21, 2013

(51) Int. Cl. G06Q 10/06

(52) U.S. Cl. CPC G06Q 10/0639
USPC 705/7.38

(57) ABSTRACT

A holiday performance report for a first-party content provider may be generated and provided based on historical performance metrics for the provider during one or more prior occurrences of a holiday event. A relevancy score may be determined for the holiday event and compared to a threshold value to determine whether the holiday event is of relevancy to the content provider.

### BACKGROUND

Online content may be received from various first-party or third-party sources. In general, first-party content refers to the primary online content requested or displayed by a user's device. For example, first-party content may be a webpage requested by the client or a stand-alone application (e.g., a video game, a chat program, etc.) running on the device. Third-party content, in contrast, refers to additional content that may be provided in conjunction with the first-party content. For example, third-party content may be a public service announcement or advertisement that appears in conjunction with a requested webpage (e.g., a search result webpage from a search engine, a webpage that includes an online article, a webpage of a social networking service, etc.) or within a stand-alone application (e.g., an advertisement within a game). More generally, a first-party content provider may be any content provider that allows another content provider (i.e., a third-party content provider) to provide content in conjunction with that of the first-party.

### SUMMARY

One implementation disclosed herein is a method of generating a holiday performance report for a first-party content provider. The method includes retrieving, from a storage device, a definition for a holiday event that includes a time period associated with the holiday event. The method also includes calculating, by one or more processors, a relevancy score for the holiday event. The method further includes comparing the relevancy score to a threshold value to determine whether the holiday event is of relevance to the first-party content provider. The method additionally includes retrieving historical performance metrics for the first-party content provider during one or more previous occurrences of the holiday event. The method yet further includes generating a holiday performance report based on the historical performance metrics. The method also includes providing the holiday performance report to an electronic device associated with the first-party content provider.

Another implementation is a system for generating a holiday performance report for a first-party content provider. The system includes one or more processors configured to retrieve, from a storage device, a definition for a holiday event that includes a time period associated with the holiday event. The one or more processors are also configured to calculate a relevancy score for the holiday event and to compare the relevancy score to a threshold value to determine whether the holiday event is of relevance to the first-party content provider. The one or more processors are further configured to retrieve historical performance metrics for the first-party content provider during one or more previous occurrences of the holiday event. The one or more processors are additionally configured to generate a holiday performance report based on the historical performance metrics and to provide the holiday performance report to an electronic device associated with the first-party content provider.

A further implementation is a computer-readable storage medium having machine instructions stored therein, the instructions being executable by a processor to cause the processor to perform operations. The operations include retrieving, from a storage device, a definition for a holiday event that includes a time period associated with the holiday event. The operations also include calculating a relevancy score for the holiday event. The operations further include comparing the relevancy score to a threshold value to determine whether the holiday event is of relevance to the first-party content provider. The operations also include retrieving historical performance metrics for the first-party content provider during one or more previous occurrences of the holiday event. The operations additionally include generating a holiday performance report based on the historical performance metrics. The operations also include providing the holiday performance report to an electronic device associated with the first-party content provider.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in which third-party content is selected for presentation with first-party content;

FIG. 2 is an illustration of an electronic display showing a first-party webpage with embedded third-party content;

FIG. 3 is a detailed block diagram of the content selection service of FIG. 1, according to various implementations;

FIG. 4 is a flow diagram of the steps taken in one implementation of a process for providing a holiday performance report to a first-party content provider;

FIG. 5A is an illustration of one implementation of a holiday performance report prior to the holiday;

FIG. 5B is an illustration of one implementation of a holiday performance report during the holiday;

FIG. 5C is an illustration of one implementation of a holiday performance report after the holiday has occurred; and

FIG. 6 is an illustration of one implementation of a holiday performance card being displayed on an electronic display.

Like reference numbers and designations in the various drawings indicate like elements.

### DETAILED DESCRIPTION

According to various aspects of the present disclosure, a first-party content provider may allow a content selection service to determine which third-party content is to be provided in conjunction with the first-party provider's content. In exchange for doing so, the first-party content provider may receive a portion of any revenues collected by the content selection service from third-party content providers. For example, a website operator may allow third-party advertisements to be selected by a content selection service for placement on the pages of the website. In turn, the content selection service may charge the third-party content providers that place content on the website a certain amount and apportion a percentage of this amount to the first-party content provider.

Any number of factors may influence the amount of earnings received by a first-party content provider in a given time period. In general, the amount of earnings received by a first-party content provider is influenced most heavily by the amount of traffic to the provider's website. In other words, the greater the number of visits to the website, the greater the opportunity to provide third-party content with the website. However, other factors also exist that may influence the earnings of a first-party content provider. For example, a provider's earnings may also be influenced by the content of the website (e.g., certain topics may be more attractive to advertisers than others), the types of visitors to the website, preferences set by the first-party content provider to control which third-party content is eligible for selection by the content selection service for presentation on the website (e.g., the first-party content provider may only allow certain types of advertisements on his or her website), and other such factors.

According to various implementations, a content selection service may be configured to generate one or more holiday performance reports for a first-party content provider. In some cases, traffic to a first-party content provider's website or other form of first-party content may differ around a holiday. Other performance metrics for a first-party content provider may also fluctuate around a holiday. For example, visitors to a particular website may be more inclined to click on third-party advertisements around Christmas than during other times of the year. Thus, the first-party content provider may also see an increase to his or her earnings around the holiday. In one implementation, a content selection service may determine whether a particular holiday is relevant to a first-party content provider. For example, Diwali, which is primarily celebrated in India, may be a relevant holiday period for a content provider that receives a certain percentage of his or her traffic from India. If the content selection service determines that the holiday is relevant to the content provider, it may generate one or more holiday performance reports for the provider. Reports may be generated for any period of time, such as a time period leading up to the holiday, during a time period associated with the actual holiday, or after the holiday has occurred. Thus, a first-party content provider may review and assess the impact of a holiday on the provider's earnings from a content selection service.

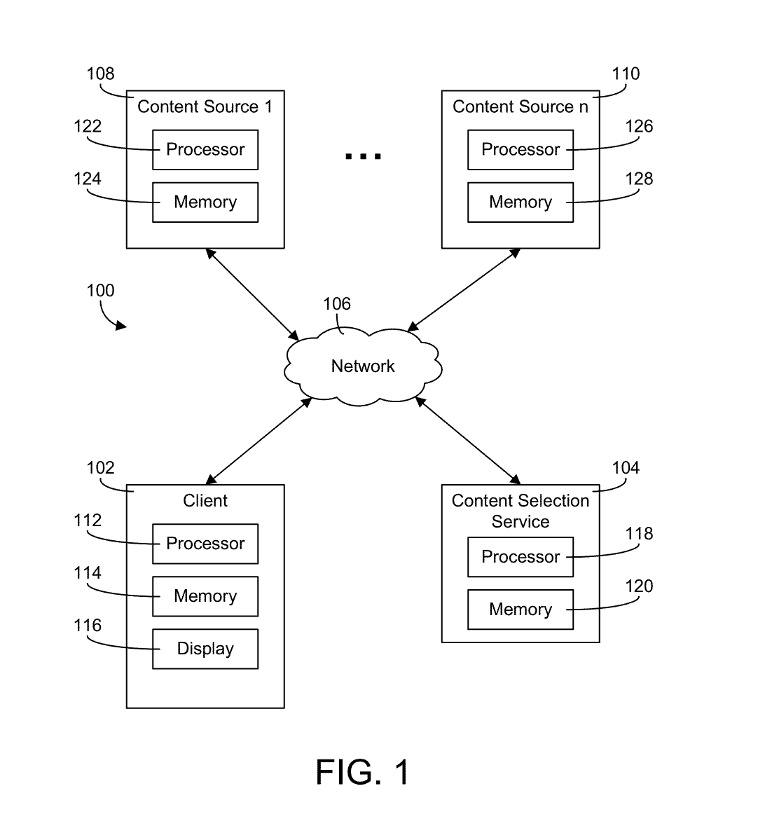

Referring to FIG. 1, a block diagram of a computer system 100 in accordance with a described implementation is shown. System 100 includes a client device 102 which communicates with other computing devices via a network 106. Client device 102 may execute a web browser or other application (e.g., a video game, a messenger program, a media player, a social networking application, etc.) to retrieve content from other devices over network 106. For example, client device 102 may communicate with any number of content sources 108, 110 (e.g., a first content source through nth content source). Content sources 108, 110 may provide webpage data and/or other content, such as images, video, and audio, to client device 102. Computer system 100 may also include a content selection service 104 configured to select third-party content to be provided to client device 102. For example, content source 108 may provide a first-party webpage to client device 102 that includes additional third-party content selected by content selection service 104.

Network 106 may be any form of computer network that relays information between client device 102, content sources 108, 110, and content selection service 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client device 102 may communicate wirelessly (e.g., via WiFi, cellular, radio, etc.) with a transceiver that is hardwired (e.g., via a fiber optic cable, a CAT5 cable, etc.) to other computing devices in network 106.

Client device 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). In some implementations, the type of client device 102 may be categorized as being a mobile device, a desktop device (e.g., a device intended to remain stationary or configured to primarily access network 106 via a local area network), or another category of electronic devices (e.g., tablet devices may be a third category, etc.). Client device 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client device 102 may include one or more user interface devices. A user interface device may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interface devices may be internal to the housing of client device 102 (e.g., a built-in display, microphone, etc.) or external to the housing of client device 102 (e.g., a monitor connected to client device 102, a speaker connected to client device 102, etc.), according to various implementations. For example, client device 102 may include an electronic display 116, which displays webpages and other data received from content sources 108, 110 and/or content selection service 104. In various implementations, display 116 may be located inside or outside of the same housing as that of processor 112 and/or memory 114. For example, display 116 may be an external display, such as a computer monitor, television set, or any other stand-alone form of electronic display. In other examples, display 116 may be integrated into the housing of a laptop computer, mobile device, or other form of computing device having an integrated display.

Content sources 108, 110 may be one or more electronic devices connected to network 106 that provide content to devices connected to network 106. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, search results, other forms of electronic documents, and applications executable by client device 102. For example, content source 108 may be an online search engine that provides search result data to client device 102 in response to a search query. In another example, content source 110 may be a first-party web server that provides webpage data to client device 102 in response to a request for the webpage. Similar to client device 102, content sources 108, 110 may include processors 122, 126 and memories 124, 128, respectively, that store program instructions executable by processors 122, 126. For example, the processing circuit of content source 108 may include instructions such as web server software, FTP serving software, and other types of software that cause content source 108 to provide content via network 106.

According to various implementations, content sources 108, 110 may provide first-party webpage data to client device 102 that includes one or more content tags. In general, a content tag refers to any piece of webpage code associated with the action of including third-party content with a first-party webpage. For example, a content tag may define a slot on a webpage for third-party content, a slot for out of page third-party content (e.g., an interstitial slot), whether third-party content should be loaded asynchronously or synchronously, whether the loading of third-party content should be disabled on the webpage, whether third-party content that loaded unsuccessfully should be refreshed, the network location of a content source that provides the third-party content (e.g., content sources 108, 110, content selection service 104, etc.), a network location (e.g., a URL) associated with clicking on the third-party content, how the third-party content is to be rendered on a display, a command that causes client device 102 to set a browser cookie (e.g., via a pixel tag that sets a cookie via an image request), one or more keywords used to retrieve the third-party content, and other functions associated with providing third-party content with a first-party webpage. For example, content source 108 may serve first-party webpage data to client device 102 that causes client device 102 to retrieve third-party content from content selection service 104. In another implementation, content may be selected by content selection service 104 and provided by content source 108 as part of the first-party webpage data sent to client device 102. In a further example, content selection service 104 may cause client device 102 to retrieve third-party content from a specified location, such as memory 114 or content sources 108, 110.

Content selection service 104 may also be one or more electronic devices connected to network 106. Content selection service 104 may be a computer server (e.g., FTP servers, file sharing servers, web servers, etc.) or a combination of servers (e.g., a data center, a cloud computing platform, etc.). Content selection service 104 may have a processing circuit including a processor 118 and a memory 120 that stores program instructions executable by processor 118. In cases in which content selection service 104 is a combination of computing devices, processor 118 may represent the collective processors of the devices and memory 120 may represent the collective memories of the devices.

Content selection service 104 may be configured to select third-party content for client device 102 (i.e., content selection service 104 may provide a third-party content selection service). In one implementation, the selected third-party content may be provided by content selection service 104 to client device 102 via network 106. For example, content source 110 may upload the third-party content to content selection service 104. Content selection service 104 may then provide the third-party content to client device 102 to be presented in conjunction with first-party content provided by any of content sources 108, 110. In other implementations, content selection service 104 may provide an instruction to client device 102 that causes client device 102 to retrieve the selected third-party content (e.g., from memory 114 of client device 102, from content source 110, etc.). For example, content selection service 104 may select third-party content to be provided as part of a first-party webpage being visited by client device 102 or within a first-party application being executed by client device 102 (e.g., within a game, messenger application, etc.).

In some implementations, content selection service 104 may be configured to select content based on a device identifier associated with client device 102. In general, a device identifier refers to any form of data that may be used to represent a device or software that receives content selected by content selection service 104. In some implementations, a device identifier may be associated with one or more other device identifiers (e.g., a device identifier for a mobile device, a device identifier for a home computer, etc.). Device identifiers may include, but are not limited to, cookies, device serial numbers, user profile data, or network addresses. For example, a cookie set on client device 102 may be used to identify client device 102 to content selection service 104.

For situations in which the systems discussed herein collect personal information about a user, or may make use of personal information, the user may be provided with an opportunity to control which programs or features collect such information, the types of information that may be collected (e.g., information about a user's social network, social actions or activities, a user's preferences, a user's current location, etc.), and/or how third-party content may be selected by content selection service 104 and presented to the user. Certain data, such as a device identifier, may be anonymized in one or more ways before it is stored or used, so that personally identifiable information is removed when generating parameters (e.g., demographic parameters) used by content selection service 104 to select third-party content. For example, a device identifier for client device 102 may be anonymized so that no personally identifiable information about its corresponding user can be determined by content selection service 104 from it. In another example, a user's geographic location may be generalized where location information is obtained (such as to a city, ZIP code, or state level), so that a precise location of the user cannot be determined. Thus, the user of client device 102 may have control over how information is collected about him or her and used by content selection service 104.

If the user of client device 102 has elected to allow content selection service 104 to use information regarding him or her, content selection service 104 may use history data associated with a device identifier to select relevant content for the corresponding user. History data may be any data associated with a device identifier that is indicative of an online event (e.g., visiting a webpage, interacting with presented content, conducting a search, making a purchase, downloading content, etc.). Based in part on the analyzed history data, content selection service 104 may select third-party content to be provided in conjunction with first-party content (e.g., as part of a displayed webpage, as a pop-up, within a video game, within another type of application, etc.). Additional data associated with a device identifier may include, but is not limited to, the device type of client device 102 (e.g., whether client device 102 is a desktop or mobile device), the location of client device 102, or a search query generated by client device 102. For example, content selection service 104 may select third-party content to be provided as part of a first-party webpage or in conjunction with search results from one of content sources 108, 110.

Content selection service 104 may analyze the history data associated with a device identifier to identify one or more topics that may be of interest. For example, content selection service 104 may perform text and/or image analysis on a webpage from content source 108, to determine one or more topics of the webpage. In some implementations, a topic may correspond to a predefined interest category used by content selection service 104. For example, a webpage devoted to the topic of golf may be classified under the interest category of sports. In some cases, interest categories used by content selection service 104 may conform to a taxonomy (e.g., an interest category may be classified as falling under a broader interest category). For example, the interest category of golf may be /Sports/Golf, /Sports/Individual Sports/Golf, or under any other hierarchical category. Similarly, content selection service 104 may analyze the content of a first-party webpage accessed by client device 102 to identify one or more topical categories for the webpage. For example, content selection service 104 may use text or image recognition on the webpage to determine that the webpage is devoted to the topical category of /Sports/Golf.

Content selection service 104 may receive history data indicative of one or more online events associated with a device identifier. In implementations in which a content tag causes client device 102 to request content from content selection service 104, such a request may include a device identifier for client device 102 and/or additional information (e.g., the webpage being loaded, the referring webpage, etc.). For example, content selection service 104 may receive and store history data regarding whether or not third-party content provided to client device 102 was selected using an interface device (e.g., the user of client device 102 clicked on a third-party hyperlink, third-party image, etc.). Content selection service 104 may store such data to record a history of online events associated with a device identifier. In some cases, client device 102 may provide history data to content selection service 104 without first executing a content tag. For example, client device 102 may periodically send history data to content selection service 104 or may do so in response to receiving a command from a user interface device. In some implementations, content selection service 104 may receive history data from content sources 108, 110. For example, content source 108 may store history data regarding web transactions with client device 102 and provide the history data to content selection service 104.

Content selection service 104 may apply one or more weightings to an interest or product category, to determine whether the category is to be associated with a device identifier. For example, content selection service 104 may impose a maximum limit to the number of product or interest categories associated with a device identifier. The top n-number of categories having the highest weightings may then be selected by content selection service 104 to be associated with a particular device identifier. A category weighting may be based on, for example, the number of webpages visited by the device identifier regarding the category, when the visits occurred, how often the topic of the category was mentioned on a visited webpage, or any online actions performed by the device identifier regarding the category. For example, topics of more recently visited webpages may receive a higher weighting than webpages that were visited further in the past. Categories may also be subdivided by the time periods in which the webpage visits occurred. For example, the interest or product categories may be subdivided into long-term, short-term, and current categories, based on when the device identifier visited a webpage regarding the category.

Content selection service 104 may be configured to conduct a content auction among third-party content providers to determine which third-party content is to be provided to client device 102. For example, content selection service 104 may conduct a real-time content auction in response to client device 102 requesting first-party content from one of content sources 108, 110 or executing a first-party application. Content selection service 104 may use any number of factors to determine the winner of the auction. For example, the winner of a content auction may be based in part on the third-party provider's bid and/or a quality score for the third-party provider's content (e.g., a measure of how likely the user of client device 102 is to click on the content). In other words, the highest bidder is not necessarily the winner of a content auction conducted by content selection service 104, in some implementations.

Content selection service 104 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at client device 102. In other words, the bid amount may be on a cost per impression or cost per thousand impressions (CPM) basis. In further cases, a bid amount may correspond to a specified action being performed in response to the third-party content being presented at a client device. For example, a bid amount may be a monetary amount that the third-party content provider is willing to pay, should their content be clicked on at the client device, thereby redirecting the client device to the provider's webpage. In other words, a bid amount may be a cost per click (CPC) bid amount. In another example, the bid amount may correspond to an action being performed on the third-party provider's website, such as the user of client device 102 making a purchase. Such bids are typically referred to as being on a cost per acquisition (CPA) or cost per conversion basis.

A campaign created via content selection service 104 may also include selection parameters that control when a bid is placed on behalf of a third-party content provider in a content auction. If the third-party content is to be presented in conjunction with search results from a search engine, for example, the selection parameters may include one or more sets of search keywords. For example, the third-party content provider may only participate in content auctions in which a search query for “golf resorts in California” is sent to a search engine. Other example parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content selection service 104 is configured to apportion a percentage of earnings from a third-party content provider to the provider of the first-party content with which the third-party content is presented. For example, content selection service 104 may apportion 40% of the revenues received from a third-party content provider to the operator of content source 108 whenever the third-party content is selected for presentation on a website from content source 108. Thus, a first-party content provider may receive revenues for allowing third-party content to be provided with the provider's content. Revenues apportioned to a first-party content provider by content selection service 104 may be based on the number of times third-party content was provided to devices (e.g., based on a number of impressions), based on whether or not a user clicked on the third-party content (e.g., a click count), or based on any other performance metric.

According to various implementations, content selection service 104 is configured to generate one or more performance reports regarding a holiday period. In some cases, performance metrics for a first-party content provider may change on or around a given holiday. In one implementation, a report may be generated by content selection service 104 that alerts a first-party content provider to an upcoming holiday. Such a report may include historical performance data for the first-party content provider from one or more previous years. For example, a report prior to the holiday period may include performance metrics from previous years for one or more time periods leading up to the holiday (e.g., one or more days prior to the holiday, several days prior to the holiday, one month prior to the holiday, etc.). In another implementation, a report may be generated by content selection service 104 during a holiday period. Such a report may include a comparison between a performance metric from the current year and from one or more previous years. In yet a further implementation, a holiday performance report may include one or more performance metrics from the most recent holiday period in comparison to those of previous years. For example, a post-holiday report may indicate that a first-party content provider's website traffic, revenue, or the like, had increased 15% over the previous year.

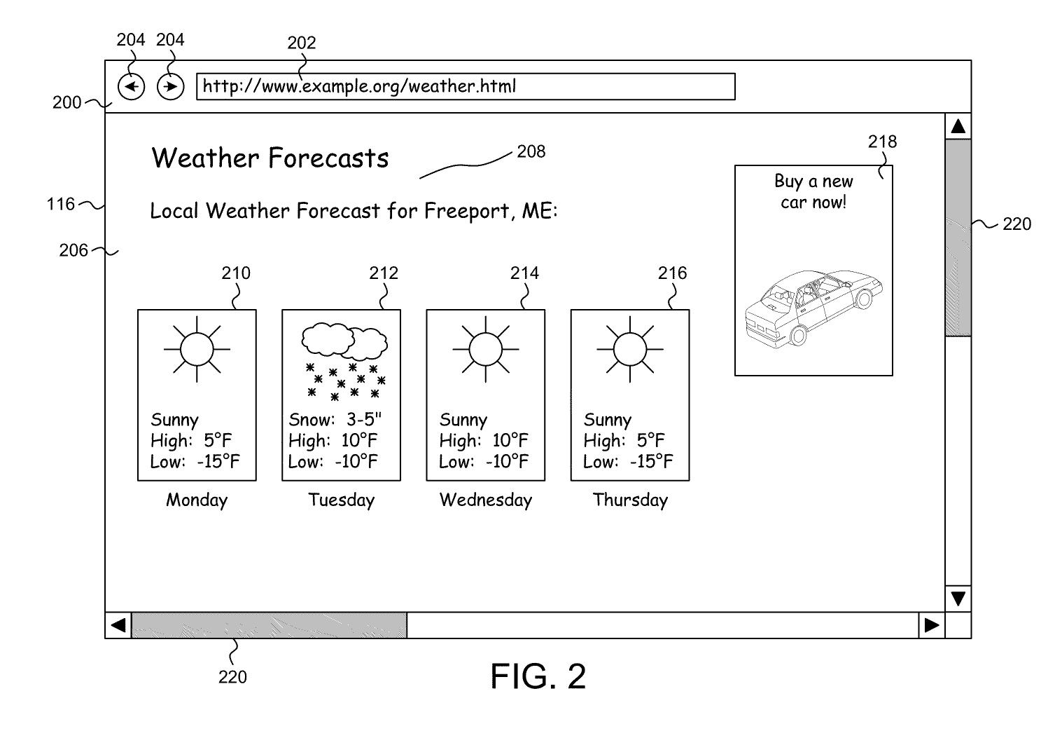

Referring now to FIG. 2, an illustration is shown of electronic display 116 displaying an example first-party webpage 206. Electronic display 116 is in electronic communication with processor 112 which causes visual indicia to be displayed on electronic display 116. As shown, processor 112 may execute a web browser 200 stored in memory 114 of client device 102, to display indicia of content received by client device 102 via network 106. In other implementations, another application executed by client device 102 may incorporate some or all of the functionality described with regard to web browser 200 (e.g., a video game, a chat application, etc.).

Web browser 200 may operate by receiving input of a uniform resource locator (URL) via a field 202 from an input device (e.g., a pointing device, a keyboard, a touch screen, etc.). For example, the URL, http://www.example.org/weather.html, may be entered into field 202. Processor 112 may use the inputted URL to request data from a content source having a network address that corresponds to the entered URL. In other words, client device 102 may request first-party content accessible at the inputted URL. In response to the request, the content source may return webpage data and/or other data to client device 102. Web browser 200 may analyze the returned data and cause visual indicia to be displayed by electronic display 116 based on the data.

In general, webpage data may include text, hyperlinks, layout information, and other data that may be used to provide the framework for the visual layout of first-party webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “weather.html” provided by the website, “www.example.org.” The webpage data may include data that specifies where indicia appear on first-party webpage 206, such as text 208. In some implementations, the webpage data may also include additional URL information used by web browser 200 to retrieve additional indicia displayed on first-party webpage 206. For example, the file, “weather.html,” may also include one or more instructions used by processor 112 to retrieve images 210-216 from their respective content sources.

Web browser 200 may include a number of navigational controls associated with first-party webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of first-party webpage 206 that are currently off-screen. For example, first-party webpage 206 may be formatted to be larger than the screen of electronic display 116. In such a case, the one or more scroll bars 220 may be used to change the vertical and/or horizontal position of first-party webpage 206 on electronic display 116.

First-party webpage 206 may be devoted to one or more topics. For example, first-party webpage 206 may be devoted to the local weather forecast for Freeport, Me. In some implementations, a content selection server, such as content selection service 104, may analyze the contents of first-party webpage 206 to identify one or more topics. For example, content selection service 104 may analyze text 208 and/or images 210-216 to identify first-party webpage 206 as being devoted to weather forecasts. In some implementations, webpage data for first-party webpage 206 may include metadata that identifies a topic.

In various implementations, content selection service 104 may select some of the content presented on first-party webpage 206 (e.g., an embedded image or video, etc.) or in conjunction with first-party webpage 206 (e.g., in a pop-up window or tab, etc.). For example, content selection service 104 may select third-party content 218 to be included on webpage 206. In some implementations, one or more content tags may be embedded into the code of webpage 206 that defines a content field located at the position of third-party content 218. Another content tag may cause web browser 200 to request additional content from content selection service 104, when first-party webpage 206 is loaded. Such a request may include one or more keywords, a device identifier for client device 102, or other data used by content selection service 104 to select content to be provided to client device 102. In response, content selection service 104 may select third-party content 218 for presentation on first-party webpage 206.

Content selection service 104 may select third-party content 218 (e.g., an advertisement) by conducting a content auction, in some implementations. Content selection service 104 may also determine which third-party content providers compete in the auction based in part on campaign parameters set by the providers. For example, only content providers that specified a topic that matches that of webpage 206, an interest category of a device identifier accessing webpage 206, or webpage 206 specifically may compete in the content auction. Based on bidding parameters for these third-party content providers, content selection service 104 may compare their bid amounts, quality scores, and/or other values to determine the winner of the auction and select third-party content 218 for presentation with webpage 206.

In some implementations, content selection service 104 may provide third-party content 218 directly to client device 102. In other implementations, content selection service 104 may send a command to client device 102 that causes client device 102 to retrieve third-party content 218. For example, the command may cause client device 102 to retrieve third-party content 218 from a local memory, if third-party content 218 is already stored in memory 114, or from a networked content source. In this way, any number of different pieces of content may be placed in the location of third-party content 218 on first-party webpage 206. In other words, one user that visits first-party webpage 206 may be presented with third-party content 218 and a second user that visits first-party webpage 206 may be presented with different content. Other forms of content (e.g., an image, text, an audio file, a video file, etc.) may be selected by content selection service 104 for display with first-party webpage 206 in a manner similar to that of third-party content 218. In further implementations, content selected by content selection service 104 may be displayed outside of first-party webpage 206. For example, content selected by content selection service 104 may be displayed in a separate window or tab of web browser 200, may be presented via another software application (e.g., a text editor, a media player, etc.), or may be downloaded to client device 102 for later use.

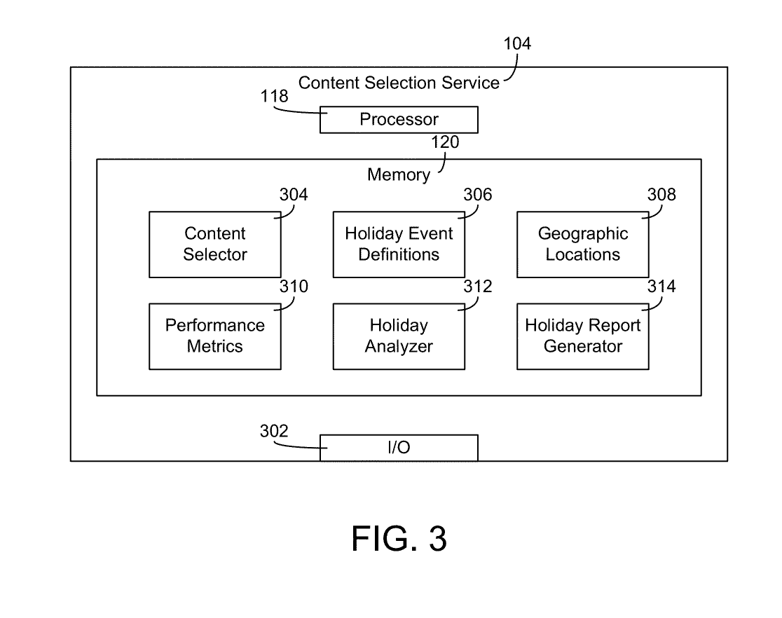

Referring now to FIG. 3, a detailed block diagram of the content selection service 104 of FIG. 1 is shown, according to various implementations. As shown, content selection service 104 may include a number of hardware components in electronic communication with one another configured to generate and provide a holiday performance report to a first-party content provider. For example, content selection service 104 may include input and/or output (I/O) hardware 302 in electronic communication with processor 118 that is configured to receive data from another computing device (e.g., an indication of an interaction with third-party content by a client device, account settings from content providers, etc.) and/or provide data to another computing device (e.g., an earnings warning, etc.) via network 106. Content selection service 104 may also include various software modules in memory 120 that, when executed by processor 118, cause processor 118 to perform the functions described herein.

Memory 120 may include a content selector 304 that is configured to select third-party content for presentation in conjunction with first-party content. In some implementations, content selector 304 may receive a content selection request via I/O hardware 302 from a client device accessing the first-party content or from the source of the first-party content itself. For example, content selector 304 may receive a content selection request from a client device in response to the client device executing a content tag embedded into a first-party webpage accessed by the client device. In response, content selector 304 may determine which piece or pieces of third-party content are to be presented with the first-party webpage.

Content selector 304 may base the selection of third-party content on any number of factors. In some implementations, content selector 304 may conduct a content auction in which bids are placed on behalf of third-party content providers. Such bids may be specified directly by the third-party content providers or generated automatically by content selector 304 based on auction parameters specified by the third-party content providers. For example, a third-party content provider may specify a minimum, maximum, or target bid as part of an advertising campaign. In another example, a third-party content provider may select a bidding strategy to achieve a particular goal (e.g., to maximize the number of impressions, clicks, conversions, etc. for the third-party content provider's content). In a further example, bids may be generated by content selector 304 on behalf of a third-party content provider based on a specified budget (e.g., a daily budget, a weekly budget, etc.). In other implementations, content selector 304 may select third-party content based on an agreement between the first-party content provider and a third-party content provider in which the third-party content provider is allowed to place content with the first-party content for a specified amount of time (e.g., a particular advertisement may be shown on the first-party provider's website for a week).

In some implementations, content selector 304 may be configured to determine whether certain third-party content is even eligible for selection for a particular piece of first-party content. For example, content selector 304 may base the eligibility of third-party content for selection on parameters set by either or both of the first and third-party content providers. In one implementation, the first-party content provider may set parameters that control which types of third-party content are eligible for presentation with the first-party content (e.g., the topics of third-party content that are prohibited or eligible for selection, whether third-party content related to a user interest category is eligible for selection, etc.). In a further implementation, the third-party content provider may specify parameters that control the types of devices for which their content is eligible for selection (e.g., desktop devices, mobile devices, specific hardware or software device configurations, etc.), the geographic locations of eligible devices, user interest categories, or the like. Thus, content selector 304 may determine whether a piece of third-party content is even eligible for selection for a particular client device or with a particular piece of first-party content before generating an auction bid on behalf of the third-party content provider.

In one implementation, content selector 304 may base the selection of third-party content on one or more quality scores. In general, a quality score may represent the likelihood of a user interacting with a piece of third-party content (e.g., clicking on the content, playing the content, etc.), how closely a third-party website hyperlinked to the third-party content relates to the third-party content, how closely a topic of the third-party content matches a topic of the first-party content, or combinations thereof. In some cases, content selector 304 may combine a quality score with a generated auction bid for a third-party content provider, to determine whether content from the provider is selected for presentation. For example, content selector 304 may add a quality score and an auction bid for a third-party content provider to determine an overall score and compare overall scores among providers, to select third-party content. Thus, the third-party content provider having a high auction bid, but a low quality score, may not be guaranteed that his or her content will be selected by content selector 304.

Memory 120 may store performance metrics 310 regarding the presentation of third-party content selected by content selector 304 with content from a first-party content provider. Performance metrics 310 may include, but are not limited to, metrics regarding traffic to one or more websites of a first-party content provider, the number of impressions for third-party content presented with first-party content (e.g., the number of times the third-party content was presented with the first-party content), the number of third-party content interactions (e.g., the number of times a user clicked on, or otherwise interacted with, the third-party content selected by content selector 304), the number of conversions associated with the third-party content (e.g., the number of times users performed a desired action, such as making an online purchase, in response to being presented the third-party content), revenues apportioned to a first-party content provider, or other similar metrics.

Performance metrics 310 may include statistical measures or other calculations based on recorded metrics. Such calculations may include rates, averages, standard deviations, or the like. For example, performance metrics 310 may include click through rates (e.g., the number of times users clicked on third-party content in relation to how many times the third-party content was presented to the users) and/or conversion rates (e.g., the percentage or ratio of times a conversion occurred as a result of third-party content being presented to users). Performance metrics 310 may also include metrics for other first-party content providers. For example, performance metrics 310 may include performance metrics regarding how other peer websites or other first-party content performs.

In some implementations, performance metrics 310 may be subdivided according to any number of time periods. For example, performance metrics 310 may be broken down on an hourly, daily, weekly, monthly, etc., basis. Performance metrics 310 for a first-party content provider may also be broken down by one or more characteristics of the devices accessing the first-party content. For example, performance metrics 310 may be subdivided based on the geographic locations of the devices accessing the first-party content, the types of devices accessing the first-party content (e.g., desktop devices, mobile devices, tablet devices, etc.), the system specifications of the devices accessing the first-party content (e.g., operating systems, hardware specifications, etc.), interest categories associated with device identifiers for the devices, or the like. Any other breakdown of performance metrics 310 may also be used, in other implementations.

Memory 120 may include holiday event definitions 306. Holiday event definitions 306 may include dates on which holidays occur. In some implementations, holiday event definitions 306 may also include one or more time periods relative to the holiday. In some cases, a holiday may be assigned to a longer or shorter time period than when the holiday actually occurs. For example, Memorial Day, which occurs each year on the final Monday of May, may be assigned a time period that includes the entire weekend in holiday event definitions 306 (e.g., for purposes of analysis and reporting, the entire weekend may be treated separately from other time periods). Holiday event definitions 306 may also include one or more time periods surrounding the time period associated with a holiday. For example, the days of the week leading up to Thanksgiving may be part of another time period associated with the Thanksgiving holiday.

In one implementation, holiday event definitions 306 may be predefined within content selection service 104. For example, an operator of content selection service 104 may predefine which holidays are included in holiday event definitions 306 and/or which time periods associated with the holidays are included in holiday event definitions 306. In another implementation, a first-party content provider may be allowed to define one or more holiday events of interest to the provider. In some cases, other forms of events may be defined in event definitions 306, such as the occurrences of trade shows or other publisher-specific events.

Memory 120 may include geographic locations 308, which may represent neighborhoods, zip codes, area codes, cities, states, countries, or any other grouping of geographic locations. In one implementation, some or all of the defined holidays in holiday event definitions may be associated with locations in geographic locations 308. For example, Diwali, a holiday primarily celebrated in India, Sri Lanka, Nepal, Myanmar, Mauritus, Guyana, Trinidad and Tobago, Suriname, Malaysia, Singapore, and Fiji, may be associated with each of these locations. Associations between a holiday in holiday event definitions 306 and one or more geographic locations may be based on whether the holiday is officially recognized as a holiday in that location, based on whether a cultural or ethnic group in the location celebrate the holiday, based on an increase in web searches from the location regarding the holiday, or based on other such factors. For example, even though Diwali is not an official holiday in the United States, the holiday may be associated with Cupertino, Calif. in content selection service 104, since Cupertino has a high population of residents of Indian descent. In another example, a much higher than average number of web searches for the holiday of Saint Joseph's Day from devices located in New Orleans, La. may indicate a regional observance of the holiday for purposes of associating the holiday's entry in holiday event definitions 306 with geographic locations 308.

Memory 120 may include a holiday analyzer 312 configured to analyze performance metrics 310 regarding one or more time periods associated with a holiday in holiday event definitions 306. In one implementation, holiday analyzer 312 may analyze holiday event definitions 306 to determine whether a particular holiday or holiday period is approaching, is occurring, or has recently occurred. Holiday analyzer 312 may use threshold amounts of time to determine whether a holiday is upcoming or has recently occurred. For example, holiday analyzer 312 may identify a holiday as upcoming if the number of days between the current date and the start of the holiday or time period representing the holiday is below a threshold amount (e.g., the holiday will occur in several days, in several weeks, etc.). In another example, holiday analyzer 312 may determine that a holiday in holiday event definitions 306 has recently occurred based on the number of days between the holiday or holiday period and the current day being below a threshold amount (e.g., the holiday ended several days ago, the holiday ended one or more weeks ago, etc.).

In one implementation, holiday analyzer 312 may determine whether a particular holiday in holiday event definitions 306 is relevant to a first-party content provider. Holiday analyzer 312 may, in some cases, determine whether a threshold amount of traffic, impressions, or other metric for a first-party content provider in performance metrics 310 is associated with one or more of the locations in geographic locations 308. If an upcoming, current, or recent holiday is also associated with that same location, holiday analyzer 312 may determine that the holiday is of relevance to the first-party content provider. For example, assume that a first-party content provider receives 40% of his or her website traffic from India. If so, holiday analyzer 312 may determine that Diwali is of relevance to the provider based on how close the current date is to the observance of Diwali. The threshold amount of a metric may be predefined or may be adjustable, in various implementations. For example, a first-party content provider may be able to specify that a holiday is of relevance if 3% or more of his or her website traffic comes from a particular location (e.g., to increase holiday sensitivity) or specify that a holiday is of relevance only if 50% or more of his or her website traffic comes from a particular location (e.g., to decrease holiday sensitivity). In a further implementation, a first-party content provider may be able to explicitly specify to holiday analyzer 312 that a given holiday is of relevance, regardless of whether the holiday is geographically associated with the performance metrics for the provider. In a further implementation, holiday analyzer 312 may determine that a holiday in holiday event definitions 306 is of relevance to a content provider based on the changes to the provider's performance being statistically significant. For example, holiday analyzer 312 may determine that Christmas is of relevance to the provider based on the traffic to the provider's website changing over the Christmas period by 5% or more. Holiday analyzer 312 may impose any preset threshold or statistic (e.g., a standard deviation) on the metric changes to determine whether the corresponding holiday is of relevance to the provider.

Holiday analyzer 312 may be configured to analyze metrics in performance metrics 310 from one or more time periods preceding the time period associated with a holiday in holiday event definitions 306. For example, holiday analyzer 312 may analyze the performance metrics of a first-party content provider from one or more days, weeks, months, etc., leading up to the holiday. In one implementation, the analyzed time periods may be from the prior year or from multiple prior years. If performance metrics from multiple years are used by holiday analyzer 312, holiday analyzer 312 may analyze each year individually or may aggregate the data across the years (e.g., by determining an average metric across the years). Holiday analyzer 312 may also analyze performance metrics from the analyzed time period in the current year. For example, if the holiday being analyzed is the U.S. holiday of Thanksgiving, which occurs at the end of November, and the time period being analyzed includes the first three weeks of November, any performance metrics from the current year from those weeks may be analyzed by holiday analyzer 312.

Holiday analyzer 312 may be configured to analyze metrics in performance metrics 310 from the actual time period associated with a holiday in holiday event definitions 306. For example, assume that the time period associated with the U.S. holiday of Thanksgiving includes the fourth Thursday through Sunday of November. In such a case, holiday analyzer 312 may analyze performance metrics of a first-party content provider from the corresponding time periods in the current and/or previous years. Where a holiday falls on different days of the year, holiday analyzer 312 may analyze the corresponding time periods from the different years of performance data.

During analysis of performance metrics for a time period, holiday analyzer 312 may determine one or more predictions or trends using the analyzed metrics. In one implementation, holiday analyzer 312 may use an exponential smoothing model to predict one or more performance metrics in the time period for the first-party content provider using the metrics in performance metrics 310. In some cases, holiday analyzer 312 may use a Holt-Winters smoothing model to predict future performance metrics. In further implementations, holiday analyzer 312 may predict future performance metrics using other forms of predictive models, such as Bayesian models or the like.

In one implementation, holiday analyzer 312 may be configured to compare performance metrics from a time period leading up to a holiday to metrics from the holiday time period. For example, holiday analyzer 312 may determine an average amount of revenues earned by a first-party website in the weeks leading up to Diwali from previous years and also for the time period of Diwali. Holiday analyzer 312 may determine one or more differences in the metrics from the two time periods. For example, holiday analyzer 312 may determine that advertising revenues earned by a particular website increases by 15% during Diwali, based on performance metrics from previous years.

In some implementations, holiday analyzer 312 may determine one or more suggested courses of action for the first-party content provider regarding an upcoming holiday. For example, if a certain percentage of a provider's website traffic comes from a geographic location that celebrates an upcoming holiday, holiday analyzer 312 may generate a notification alerting the provider to this fact. Such a notification may include suggestions, such as modifying the website to include content related to the holiday. For example, a notification about Christmas may include a suggestion to add Christmas-themed content to the website. In one implementation, holiday analyzer 312 may suggest changes to the provider's settings used by content selector 304 to present third-party content on the website. For example, a first-party content provider may allow certain types of third-party content to appear on a website during a holiday period, to increase the likelihood of a user clicking on the third-party content.

After the occurrence of a holiday time period, holiday analyzer 312 may analyze the most current performance metrics for that time period and/or metrics from previous years. For example, holiday analyzer 312 may determine the number of webpage views or advertising revenue earned during the recent Diwali festival and for one or more previous years. Holiday analyzer 312 may also compare performance metrics from any number of divisions of performance metrics 310, such as the different geographic locations of the client devices. Holiday analyzer 312 may also calculate one or more statistics based on a comparison across different years. For example, holiday analyzer 312 may determine that a first-party website received 25% more traffic during the most recent Diwali festival than in the previous year. In one implementation, holiday analyzer 312 may calculate a baseline performance metric for a first-party content provider using metrics for the provider from other time periods. For example, holiday analyzer 312 may use performance metrics from the rest of the year (e.g., from outside of the holiday period under analysis) to generate a baseline performance metric for the first-party content provider. Holiday analyzer 312 may further compare current or previous performance metrics of a provider to the determined baseline. For example, holiday analyzer 312 may determine one or more differences between a provider's website traffic during the holiday period in the current year, during the holiday period in one or more previous years, and during the rest of the year.

In addition to analyzing performance metrics for a first-party content provider, holiday analyzer 312 may analyze metrics from one or more other providers, in some implementations. The other providers, in some cases, may be identified by holiday analyzer 312 based on the providers having one or more shared characteristics. For example, holiday analyzer 312 may identify other first-party websites that have similar traffic patterns as the provider under analysis, other first-party websites that have similar topics as that of the provider under analysis, or the like. Holiday analyzer 312 may aggregate performance metrics from the other content providers to determine averages, standard deviations, or other statistical measures from the providers. In one implementation, holiday analyzer 312 may determine a peer baseline set of performance metrics using the metrics from the other content providers. For example, holiday analyzer 312 may determine a peer baseline amount of website traffic for other content providers based on performance metrics for the providers from one or more previous years. Holiday analyzer 312 may further compare a peer baseline performance metric to those of the provider under analysis. For example, holiday analyzer 312 may determine that traffic to the content provider's website is in the 90^{th} percentile during the holiday in comparison to the websites of peer providers.

Memory 312 may also include a holiday report generator 314 configured to generate one or more reports using data from holiday analyzer 312. The reports may correspond to any number of time periods relative to that of a holiday. For example, holiday report generator 314 may generate one type of report in the time period leading up to a holiday, another type of report during the holiday, and another report after the conclusion of the holiday. A report leading up to a holiday may include actual or predicted performance metrics for the content provider relative to the holiday period. For example, a report during a time period leading up to Diwali may indicate the traffic differences to the provider's website relative to the holiday period, based on performance metrics from previous years. In one implementation, a report during a holiday period may include up-to-date performance metrics for the first-party content provider, metrics from the corresponding period in previous year, a baseline performance metric from times outside of the holiday period, or the like. In a further implementation, a report after a holiday period may include the most recent set of metrics from the holiday period, metrics from previous years, baseline metrics, or the like.

In some implementations, a report generated by holiday report generator 314 may be for a particular subset of performance metrics 310. For example, a report generated during a holiday period may be limited to performance metrics associated with devices in a particular geographic location. In some implementations, holiday report generator 314 may generate a holiday performance report for a subset of performance metrics 310 if holiday analyzer 312 determines the metrics to be statistically significant. For example, assume that holiday analyzer 312 determines that the holiday of Diwali is of relevance to a particular content provider based on website traffic to the provider's website from a given geographic location. In such a case, a report generated by holiday report generator 312 may include metrics specific to that geographic location and/or may include metrics across all geographic locations.

Holiday report generator 314 may be configured to generate and provide a report to a device associated with a first-party content provider. For example, holiday report generator 314 may provide a holiday performance report as part of a webpage, as data sent to a stand-alone application executed by the device (e.g., a mobile application or other application specifically configured to display the report), as an email, as a text message, or the like. In some implementations, the report generated by holiday report generator 314 may be included as part of a reporting or insight card (e.g., a widget application that aggregates performance metrics and may be presented with other widgets). Holiday report generator 314 may also provide the report on a push or pull basis. For example, holiday report generator 314 may provide a holiday performance report in response to determining that an upcoming or occurring holiday is of relevance to a content provider. In another example, holiday report generator 314 may provide the report in response to a request for data from the device associated with the content provider (e.g., the content provider logs into his or her account, etc.).

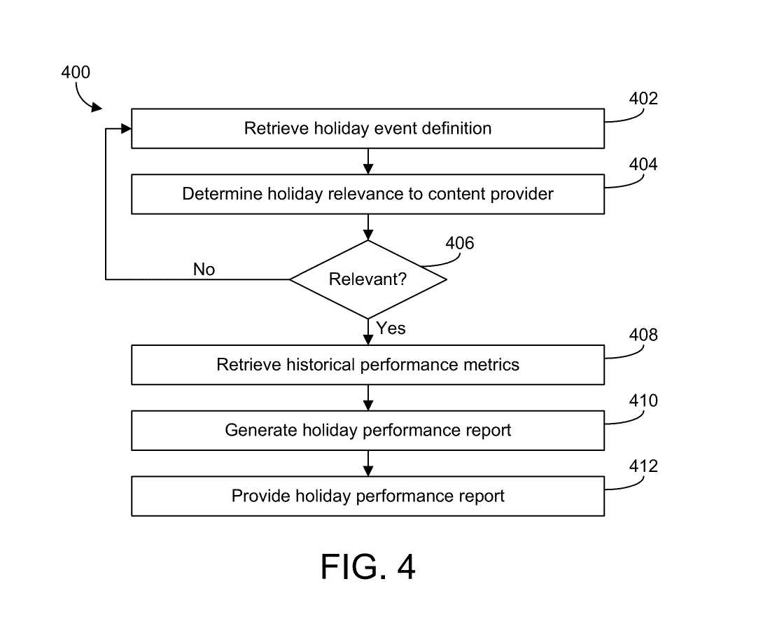

Referring now to FIG. 4, a flow diagram of a process 400 for providing a holiday performance report to a first-party content provider is shown, according to various implementations. Process 400 generally includes retrieving a definition for a holiday event (step 402), determining the relevance of a holiday to a content provider (step 404), assessing whether the holiday is of relevance to the provider (step 406), retrieving historical performance metrics for the provider if the holiday is relevant (step 408), generating a holiday performance report for the provider (step 410), and providing the report to a device associated with the content provider (step 412). Process 400 may be implemented by one or more computing devices executing stored machine instructions. For example, process 400 may be implemented by content selection service 104 shown in detail in FIG. 3. In general, process 400 allows a first-party content provider to quickly assess and detect potential changes to the performance of the provider's content relative to a holiday period.

Still referring to FIG. 4 and in more detail, process 400 includes retrieving a holiday event definition from a storage device (step 402). In one implementation, for example, content selection service 104 may retrieve a holiday event definition from holiday event definitions 306 shown in FIG. 3. A holiday event definition may include any information about the holiday, such as background information on the holiday (e.g., the origin of the holiday, etc.), when the holiday is observed (e.g., on a specific date or date range, at a particular time of the month, etc.), a time period for the holiday (e.g., the holiday itself and/or a length of time surrounding the observance of the holiday, such as the entire week or weekend), and the like. In one implementation, a retrieved holiday event definition may be associated with one or more geographic locations in which the holiday is observed. For example, the geographic location of India may be retrieved with the event definition for the holiday of Diwali. The retrieved holiday event definition may be predefined by the operator of the content selection service or may be set by each individual content provider.

Referring yet still to FIG. 4, process 400 may include determining the relevance of the holiday to a first-party content provider (step 404). In one implementation, a holiday may be determined to be of relevance to the provider based on one or more performance metrics for the provider being associated with the same geographic location associated with the holiday. For example, if a threshold amount of traffic to the provider's website is from the geographic location in which the holiday is observed, the holiday may be deemed to be of relevance. The threshold used to determine whether a holiday is of relevance to a particular first-party content provider may be hardcoded or otherwise fixed in the content selection service, set manually by a content provider, may be specific to a type of performance metric, etc. In another implementation, the holiday may be determined to be of relevance to the provider based on a threshold amount of change to the provider's performance during or around the holiday period. For example, Christmas may be determined to be of relevance to a provider based on a spike in the provider's traffic around Christmas, regardless of the geographic locations of devices accessing the provider's content. In a further implementation, the first-party content provider may manually specify that the holiday is of relevance (e.g., the provider may override the content selection service's determination regarding the relevancy of the holiday to the provider). Relevancy may further be determined based on the current date relative to the time period of the holiday. For example, the relevancy of the holiday may increase the closer the current date is to the holiday period. In some cases, a relevancy score may be determined by the content selection service to represent the overall relevancy of the holiday to the content provider.

Referring still to FIG. 4, process 400 may include a decision step at which process 400 branches depending on the relevancy of the holiday to the content provider (step 406). In some implementations, a relevancy score calculated in step 404 may be compared to a threshold value in step 406 to determine whether or not the holiday is currently of relevance to the content provider. If the holiday under analysis is determined not to be of relevance (e.g., its relevancy score is below a threshold value), process 400 may conclude or steps 402-404 may be repeated until a holiday is determined to be of relevance to the first-party content provider. If the holiday is determined to be relevant, however, process 400 may proceed to the execution of steps 408-412 to generate and provide a holiday performance report to the provider regarding the holiday.

Referring yet still to FIG. 4 and to process 400, process 400 may include retrieving historical performance metrics for the content provider from the holiday period and/or from one or more time periods surrounding the holiday period (step 408). The historical performance data may include performance metrics from the current year, the previous year, and/or from multiple years prior to the current year. Performance metrics may include, but are not limited to, metrics regarding traffic to the provider's website, usage metrics of a provider's application or other form of content, an impression count, a click count, a conversion count, or the like. The performance metrics may also include calculated metrics, such as average or weighted average values (e.g., a weighted average of traffic metrics in prior years may be weighted to give the highest weighting to the year immediately prior to the current year). The performance metrics may also include rates or other calculated values relative to one another, such as click through rates, conversion rates, or the like.

Referring still to FIG. 4, process 400 may include generating a holiday performance report using the retrieved performance metrics (step 410). As shown in FIG. 3, for example, report generator 314 may generate a holiday performance report using data analyzed by holiday analyzer 312. In one implementation, a generated holiday performance report may include one or more baseline metrics. A baseline metric may represent the performance of the provider outside of the holiday period. In some cases, a baseline metric may represent the performance of peer content providers, such as those having similar users or similar content. In some implementations, a holiday performance report may include one or more comparisons between performance metrics in the current year, performance metrics from one or more previous years, and/or any baseline metrics. For example, a holiday performance report generated during the observance of a holiday may include data regarding the provider's current performance, the provider's performance in previous years, and/or a baseline performance of the provider outside of the holiday period. In some implementations, a generated holiday performance report may include data specific to only a subset of client devices. For example, a holiday performance report may be specific to performance metrics for devices located in a particular geographic location.

In some implementations, a generated holiday performance report may include one or more suggestions to the provider regarding the holiday. For example, a generated report may suggest that a first-party webpage be modified to address the holiday. The report may also include suggestions to change content selection parameters set by the provider in the content selection service for the holiday period. For example, the report may include a suggested change to the allowed topics of third-party content for the holiday period.

Yet still referring to FIG. 4, process 400 may include providing the generated holiday performance report to a device associated with the content provider (step 412). As shown in FIG. 3, for example, holiday report generator 314 executed by processor 118 may provide a generated report to a network device via I/O hardware 302. In one implementation, the report may be provided on a push basis (e.g., the report may be provided in response to the report being generated). In another implementation, the report may be provided on a pull basis (e.g., in response to a request for such information from the device associated with the content provider). In various implementations, the generated report may be part of a card or widget configured to analyze a provider's performance and present warnings or other statistics regarding the performance. For example, the report may be provided as part of a card or widget on a webpage served to the device or as an add-on to a stand-alone application executed by the device (e.g., a mobile application or other software specifically configured to access performance data from a content selection service).

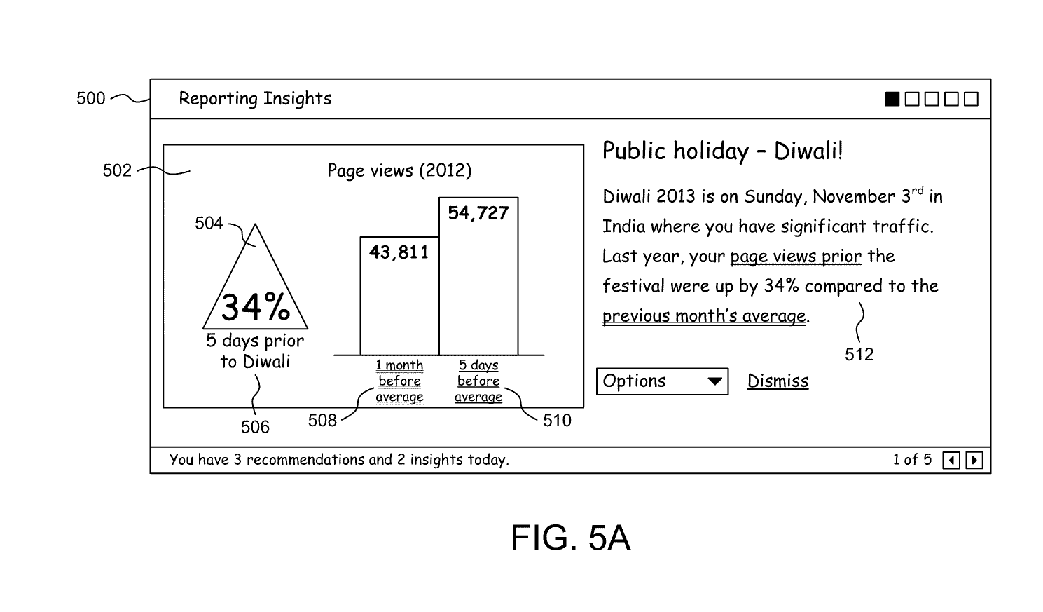

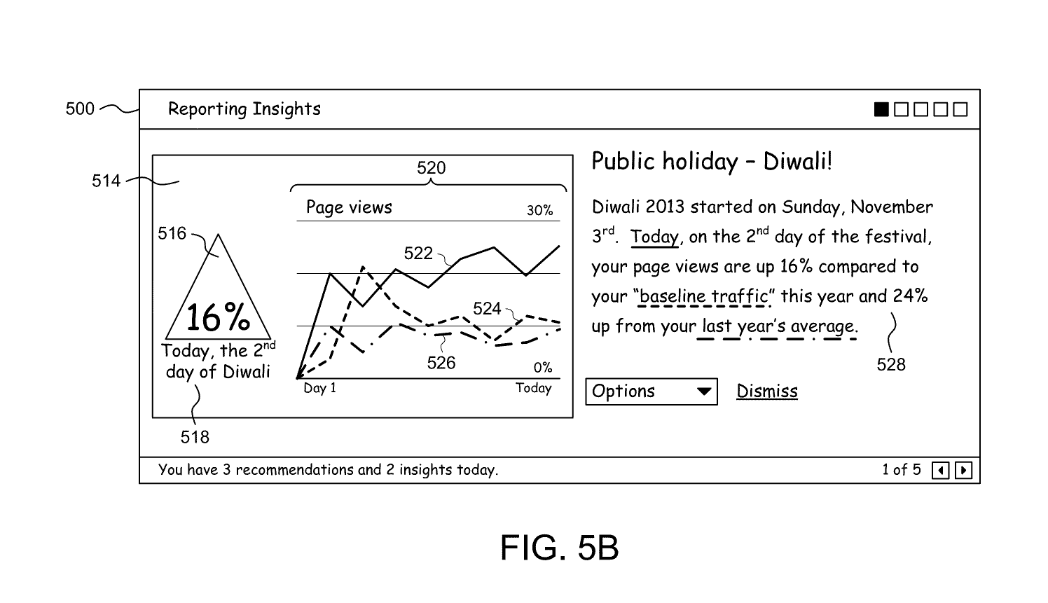

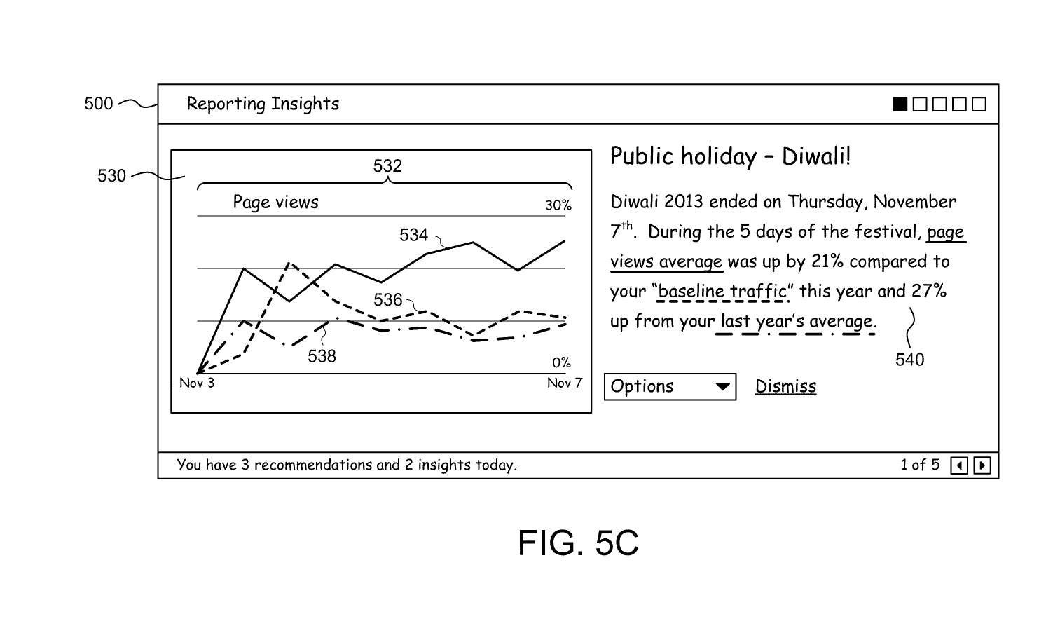

Referring now generally to FIGS. 5A-5C, illustrations are shown of various implementations in which holiday reports are generated and presented on an electronic display 500. Typically, electronic display 500 is part of an electronic device associated with a first party content provider (e.g., a desktop device, a mobile device, etc.), but may also be associated with any interested party. As shown in the implementation of FIG. 5A, a holiday performance report 502 may be generated and presented prior to the start of a holiday period. As shown in the implementation of FIG. 5B, another holiday performance report 514 may be generated and presented during the occurrence of a holiday period. As shown in the implementation of FIG. 5C, yet another performance report 530 may be generated and presented after the occurrence of the holiday period. Holiday performance reports 502, 514, 530 may be generated by a content selection service or one or more other computing devices that receive and analyze performance metrics regarding a first-party content provider, in various implementations, such as content selection service 104 shown in FIG. 3. Holiday performance reports 502, 514, 530 may also be webpages or may be part of a stand-alone application, such as a mobile application specifically configured to access a content selection service and to present holiday performance reports 502, 514, 530 on electronic display 500.

Referring now to the implementation of FIG. 5A in greater detail, holiday performance report 502 may be generated during any time period leading up to the start of a particular holiday period. For example, holiday performance report 502 may be generated several weeks before the start of Diwali. Holiday performance report 502 may include various metrics and other information that enable a first-party content provider to evaluate the performance of his or her content over the holiday. In one implementation, holiday performance report 502 may include performance metrics from one or more time periods leading up to the holiday. For example, holiday performance report 502 may include page view metrics 508, which correspond to the average number of page views for the provider in the month leading up to Diwali. Similarly, holiday performance report 502 may include page view metrics 510, which correspond to the average number of page views for the provider in the five days leading up to the start of Diwali. Metrics 508, 510 may be calculated based on the performance metrics of the first-party content provider in the previous year, multiple prior years, the entire performance history for the provider, or may even be generated using performance metrics from other content providers, in various implementations.

Holiday performance report 502 may include graphics and/or text that convey information such as the amount of time until the start of a holiday and the effect of the holiday on the provider's performance metrics. For example, holiday performance report 502 may include an arrow or other graphic 504 that indicates that the number of visits to the provider's website increased by 34% in the five days leading up to Diwali. Associated with graphic 504 may be text 506 that indicates the time period corresponding to the percentage increase (e.g., that the provider's traffic increased in the days leading up to Diwali, based on the prior year's traffic). Holiday performance report 502 may further include text 512 that explains the significance of Diwali to the content provider (e.g., that the provider has a significant amount of traffic from India, where Diwali is celebrated). In some implementations, text 512 may include suggested changes to the provider's content or to the provider's settings in the content selection service. For example, text 512 may suggest that the provider modify his or her website to acknowledge Diwali, to increase traffic within the provider's website.

According to various implementations, holiday performance report 502 is generated automatically on behalf of a first-party content provider (e.g., not in response to a request for the report from the provider). Holiday performance report 502 may be generated, for example, based on a determination that Diwali may be of relevance to the content provider. A relevancy score may be determined, in some implementations, based on the amount of traffic to the provider's website from a geographic location that celebrates the holiday, based on a detectable change in the provider's performance around the holiday, or the like. Such a relevancy score may also be based in part on the amount of time until the next occurrence of the holiday. For example, the relevancy score for Diwali may increase the closer the current date is to Diwali. If the relevancy score for Diwali exceeds a predefined threshold, holiday performance report 502 may be generated and presented to electronic display 500. Thus, performance data from prior years surrounding a holiday may be used to proactively alert a content provider about an upcoming holiday.

Referring now to the implementation of FIG. 5B in greater detail, holiday performance report 514 may be generated during the time period associated with the holiday. For example, holiday performance report 514 may be generated on the second day of Diwali. Holiday performance report 514 may include various performance metrics and comparisons to assist the first-party content provider in assessing the performance of his or her content during the current holiday period. Holiday performance report 514 may include a graphic 516 that indicates the amount of increase or decrease in a performance metric during a given time period 518. For example, graphic 516 may indicate a 16% increase in page views during the second day of Diwali in comparison to a baseline amount of traffic.

Holiday performance report 514 may include a chart or graph 520 that displays the current, historical, and/or baseline performance metric during the holiday period. For example, the current number of page views 522 for the provider's website from the start of Diwali may be included on graph 520. Similarly, the historical page views 526 of the provider's content during one or more prior years may be included on graph 520. Graph 520 may further include a measure of the baseline page views 524. Baseline page views 524 may be, in various implementations, average performance metrics of the provider during other times of the year, average performance metrics of other providers during the holiday period, average performance metrics of other providers during other times of the year, or the like. For example, baseline page views 524 may be an average set of page views based on the provider's page views on Sundays and Mondays throughout the year, since the current holiday period spans a Sunday and Monday.

Holiday performance report 514 may further include text 528 that alerts the content provider to the current status of the holiday (e.g., it is currently the second day of Diwali), as well as a textual explanation of the provider's performance metric. In one implementation, text 528 may include suggestions or tips for the content provider to improve the performance metric. For example, text 528 may include a suggestion that the provider alternate Diwali-related content on his or her website to focus on Naraka Chaturdashi, the festival that falls on the second day of Diwali. Other suggestions may include suggested changes to the provider's settings in the content selection service (e.g., which types of third-party content may be selected, how the third-party content is selected, etc.).

In some implementations, holiday performance report 514 is automatically generated and presented based on a determination that the report is of relevance to the first-party content provider. In one implementation, holiday performance report 514 may be generated based on the same or similar relevancy score associated with holiday performance report 502. In other words, holiday performance report 514 may be presented to the first-party content provider during the holiday period, if holiday performance report 502 was generated and presented prior to the holiday period. In another implementation, holiday performance report 514 may be generated and presented based on its own relevancy score. For example, assume that the content provider's traffic during the current holiday period remains close to that of the baseline traffic and the traffic from previous years. In such a case, holiday performance report 514 may have a lower relevancy score and may even be hidden or otherwise not generated. However, if the traffic in the current holiday period deviates significantly from that of the baseline or from previous years, the relevancy score may be higher, thereby causing holiday performance report 514 to be generated and presented on electronic display 500.

Referring now to the implementation of FIG. 5C in greater detail, holiday performance report 530 may be generated and presented after the occurrence of a holiday period. As shown, holiday performance report 530 may be generated and displayed after a holiday period has completed. Holiday performance report 530 may generally include any or all of the indicia of holiday performance report 514, but including data through the end of the holiday period. For example, holiday performance report 530 may include a chart or graph 532 containing similar performance metrics as graph 520 in performance report 514. In other words, graph 532 may include data regarding the current page views 534 in the most recent holiday period, the baseline page views 536 (e.g., based on the provider's weekly averages, etc.), and/or historical page views 538 during the holiday period in one or more prior years. Holiday performance report 530 may further include text 540 that indicates that the holiday period has ended, a textual explanation of graph 532, possible suggested actions for the content provider (e.g., a reminder to remove Diwali-related content from the provider's website, etc.), or the like.

In some implementations, holiday performance report 530 is generated and presented automatically based on the completion of the holiday period or at a predefined time thereafter (e.g., one day after the holiday period ended, one week after the holiday period ended, etc.). In further implementations, holiday performance report 530 may be generated in response to a request for the report from the content provider. For example, assume that in July, the content provider wishes to review his or her website's performance during the last Diwali festival in November. In response to a request for the report, the content selection service may generate holiday performance report 530 for the content provider.

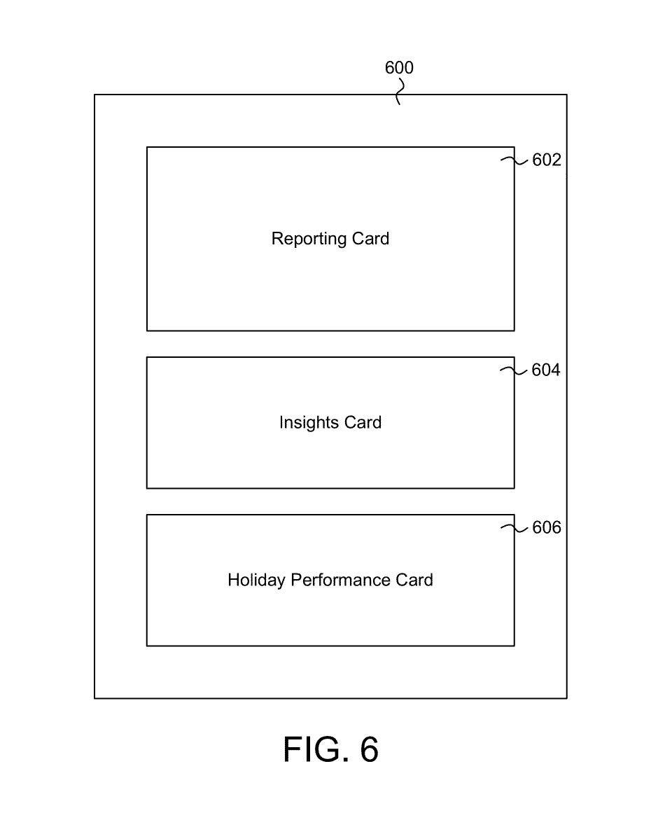

Referring now to FIG. 6, an illustration is shown of one implementation of a holiday performance card 606 being displayed on an electronic display 600. In general, a card refers to any application add-on, widget, or the like in which a particular type of information is grouped and presented. In various implementations, a single application may be configured to support the use of multiple cards. For example, an application for a mobile device (i.e., a mobile app) may support cards devoted to the weather forecast, travel information (e.g., flight times, traffic delays, etc.), and the like. As shown in FIG. 6, cards 602-606 for use by a first-party content provider may be included as part of the same application or interface (e.g., a webpage) that presents information regarding the provider's account with a content selection service. Each of cards 602-606 may be generated by a card service (e.g., the content selection service or another computing device in communication therewith) and provided to the device having display 600. For example, the card service may be implemented as an application programming interface (API). Card sources (e.g., sources of data used in the cards) may be registered with the card service and queried (e.g., via API or another mechanism) for data each time the card service receives an applicable request. In one implementation, card sources may be queried in parallel by the service. In some implementations, the service may impose a time deadline on the card services to report their respective data. After the deadline, the service may collate all returned cards and provide the cards to any client devices, such as the device having display 600. The card service may also impose a limit on the number of cards and/or the number of cards of a certain type for the client device. In one implementation, the card service may only query card sources associated with card types that are supported by the client device.

Card 602 may be a card configured to report on traffic to a first-party content provider's website, revenues earned by the provider by allowing third-party content to be included with the website, performance comparisons with peer websites, or any other performance metric for the provider's content. Card 602 may include text, graphs, charts, or any other form of indicia regarding the reports. For example, card 602 may include information regarding the monthly earnings of the provider in relation to those of peer providers (e.g., providers that have websites devoted to the same topics, websites that have similar traffic, etc.). In one implementation, card 602 may include earnings estimates for the provider. For example, card 602 may display a chart that shows the actual and predicted earnings of the provider.

Card 604 may be an insight card configured to give the provider greater insight into his or her performance. In general, an insight card uses data aggregated from one or more card sources to identify trends or changes in the provider's performance. For example, card 604 may provide a comparison between earnings by the provider in different months or years. In another example, an insight card may be associated with a particular event, such as if the provider redesigns his or her website. In one implementation, an insight card may be generated and presented automatically (e.g., without first receiving a request for such information from the content provider). For example, an insight card may be generated and presented based on a relevancy score associated with the card. Such a relevancy score may be used to control which cards are displayed on electronic display 600, the ordering of the cards, etc.

Card 606 may be a holiday performance card configured to report on a content provider's performance relative to a holiday period. Card 606 may be, in various implementations, holiday performance cards generated before, during, or after the occurrence of the holiday period. For example, any of holiday performance reports 502, 514, 530 shown in FIGS. 5A-5C may be implemented as cards. In some implementations, card 606 is generated automatically based on a determination that the corresponding holiday period is of relevance to the content provider. This determination may be based in part on the geographic locations of devices that access the provider's content (e.g., based on whether consumers of the content are likely to observe the holiday), on any observed changes in one or more performance metrics of the provider during previous holiday periods, based on a setting specifying the holiday period as being of interest, or the like. Relevancy may further be determined based on the relationship between the current date and the holiday period. For example, a holiday period may become more relevant as the current date approaches the holiday period.

Cards 602-606 may be presented on display 600 at any time, according to various implementations. In some implementations, cards 602-606 are assigned priorities by the card service that are used to control which cards are displayed on display 600. For example, holiday performance card 606 may be assigned a high priority whenever a relevant holiday period is occurring. Cards having priority scores less than a predefined minimum may have a random offset added to their priority scores, thereby causing these cards to be randomly shown during different login events. In some implementations, the provider may also control which cards are even eligible to be shown. For example, the content provider may be able to select an option to never see card 604 again or to add cards that are of interest to the provider.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method of generating a holiday performance report for a first-party content provider comprising:
retrieving, from a storage device, a definition for a holiday event that comprises a time period associated with the holiday event;
calculating, by one or more processors, a relevancy score for the holiday event;
comparing the relevancy score to a threshold value to determine whether the holiday event is of relevance to the first-party content provider;
retrieving historical performance metrics for the first-party content provider during one or more previous occurrences of the holiday event;
generating a holiday performance report based on the historical performance metrics; and
providing the holiday performance report to an electronic device associated with the first-party content provider.

2. The method of claim 1, wherein calculating the relevancy score for the holiday event comprises:
associating the holiday event with a geographic location; and
determining that a threshold amount of devices that access content from the first-party content provider are located in the geographic location.

3. The method of claim 1, wherein generating the holiday performance report comprises:
generating a baseline performance metric for the first-party content provider using performance metrics from time periods outside of the time period associated with the holiday event.

4. The method of claim 1, wherein calculating the relevancy score for the holiday event comprises:
associating the holiday event with a geographic location; and
determining that a number of devices that accessed content from the first-party content provider and are located in the geographic location have performed searches regarding the holiday event.

5. The method of claim 1, wherein generating the holiday performance report comprises:
determining performance metrics of the content provider from a time period leading up to the time period associated with the holiday event.

6. The method of claim 1, wherein generating the holiday performance report comprises:
determining performance metrics of the content provider during the time period associated with the holiday event.

7. The method of claim 1, further comprising:
providing the holiday performance report within a card of a stand-alone application.

8. A system for generating a holiday performance report for a first-party content provider comprising one or more processors configured to:
retrieve, from a storage device, a definition for a holiday event that comprises a time period associated with the holiday event;
calculate a relevancy score for the holiday event;
compare the relevancy score to a threshold value to determine whether the holiday event is of relevance to the first-party content provider;
retrieve historical performance metrics for the first-party content provider during one or more previous occurrences of the holiday event;
generate a holiday performance report based on the historical performance metrics; and
provide the holiday performance report to an electronic device associated with the first-party content provider.

9. The system of claim 8, wherein the one or more processors are configured to calculate the relevancy score for the holiday event by:
associating the holiday event with a geographic location; and
determining that a threshold amount of devices that access content from the first-party content provider are located in the geographic location.

10. The system of claim 8, wherein the one or more processors are configured to generate a baseline performance metric for the first-party content provider using performance metrics from time periods outside of the time period associated with the holiday event.

11. The system of claim 8, wherein the one or more processors are configured to:
associate the holiday event with a geographic location; and
determine that a number of devices that accessed content from the first-party content provider and are located in the geographic location have performed searches regarding the holiday event.

12. The system of claim 8, wherein the one or more processors are configured to:
determine performance metrics of the content provider leading up to the time period associated with the holiday event.

13. The system of claim 8, wherein the one or more processors are configured to:
determine performance metrics of the content provider during the time period associated with the holiday event.

14. The system of claim 8, wherein the one or more processors are configured to:
provide the holiday performance report within a card of a stand-alone application.

15. A computer-readable storage medium having machine instructions stored therein, the instructions being executable by a processor to cause the processor to perform operations comprising:
retrieving, from a storage device, a definition for a holiday event that comprises a time period associated with the holiday event;
calculating a relevancy score for the holiday event;
comparing the relevancy score to a threshold value to determine whether the holiday event is of relevance to the first-party content provider;
retrieving historical performance metrics for the first-party content provider during one or more previous occurrences of the holiday event;
generating a holiday performance report based on the historical performance metrics; and
providing the holiday performance report to an electronic device associated with the first-party content provider.

16. The computer-readable storage medium of claim 15, wherein calculating the relevancy score for the holiday event comprises:
associating the holiday event with a geographic location; and
determining that a threshold amount of devices that access content from the first-party content provider are located in the geographic location.

17. The computer-readable storage medium of claim 15, wherein generating the holiday performance report comprises:
generating a baseline performance metric for the first-party content provider using performance metrics from time periods outside of the time period associated with the holiday event.

18. The computer-readable storage medium of claim 15, wherein calculating the relevancy score for the holiday event comprises:
associating the holiday event with a geographic location; and
determining that a number of devices that accessed content from the first-party content provider and are located in the geographic location have performed searches regarding the holiday event.

19. The computer-readable storage medium of claim 15, wherein generating the holiday performance report comprises:
determining performance metrics of the content provider leading up to the time period associated with the holiday event.

20. The computer-readable storage medium of claim 15, wherein generating the holiday performance report comprises:
determining performance metrics of the content provider during the time period associated with the holiday event.
